(19) United States
(12) Patent Application Publication
(10) Pub. No.: US 2004/0033926 A1
(43) Pub. Date: Feb. 19, 2004

(54) Cleaning wipe

(75) Inventors: Gregory Szewczyk, Flemington, NJ (US); Barbara Thomas, Princeton, NJ (US); Karen Wisniewski, Bound Brook, NJ (US)

Correspondence Address: Patent Department, Colgate-Palmolive Company, P.O. Box 1343, 909 River Road, Piscataway, NJ, 08855-1343, US

(73) Assignee: Colgate-Palmolive Company

(21) Appl. No.: 10/645,239

(22) Filed: Aug. 21, 2003

Related U.S. Application Data
(63) Continuation-in-part of application No. 10/412,909, filed on Apr. 14, 2003, now Pat. No. 6,649,584.
Application No. 10/412,909 is a continuation-in-part of application No. 10/086,165, filed on Feb. 27, 2002, now Pat. No. 6,432,904.
Application No. 10/086,165 is a continuation-in-part of application No. 10/008,715, filed on Nov. 13, 2001, now Pat. No. 6,440,925.

(51) Int. Cl. C11D 17/00

(52) U.S. Cl. 510/438

(57) ABSTRACT

The present invention relates to a cleaning wipe which is a water insoluble substrate impregnated with a cleaning composition.

### RELATED APPLICATION

This application is a continuation in part application of U.S. Ser. No. 10/412,909 filed Apr. 14, 2003 which in turn is a continuation in part application of U.S. Ser. No. 10/086,165 filed Feb. 27, 2002 which in turn is a continuation in part application of U.S. Ser. No. 10/008,715 filed Nov. 13, 2001.

### FIELD OF INVENTION

The present invention relates to a cleaning wipe for dishware, teeth, human skin, hair and fabric which is a single or multi layer fabric substrate which has been impregnated with a liquid cleaning composition.

### BACKGROUND OF THE INVENTION

The patent literature describes numerous wipes for both body cleaning, oral cleaning, fabric cleaning, hair cleaning and cleaning of hard surfaces but none describe wipes for cleaning teeth, human skin, hair, fabrics or cleaning dishware, flatware, pots and pans. U.S. Pat. Nos. 5,980,931, 6,063,397and 6,074,655 teach a substantially dry disposable personal cleansing product useful for both cleansing and conditioning the skin and hair. U.S. Pat. No. 6,060,149 teaches a disposable wiping article having a substrate comprising multiple layers.

U.S. Pat. Nos. 5,756,612; 5,763,332; 5,908,707; 5,914,177; 5,980,922 and 6,168,852 teach cleaning compositions which are inverse emulsions.

U.S. Pat. Nos. 6,183,315 and 6,183,763 teach cleaning compositions containing a proton donating agent and having an acidic pH. U.S. Pat. Nos. 5,863,663; 5,952,043; 6,063,746 and 6,121,165 teaches cleaning compositions which are oil in water emulsions.

### SUMMARY OF THE INVENTION

A single use cleaning wipe for dishwashing application comprises a water insoluble substrate, impregnated with a cleaning composition containing four anionic surfactants, an amine oxide surfactant and water.

The liquid cleaning compositions of this invention are not an emulsion and do not contain potassium sorbate, a polysaccharide polymer, a polycarboxylate polymer, polyvinyl alcohol polymer, polyvinylpyrrolidone polymer or methyl vinyl ether polymer.

### DETAILED DESCRIPTION OF THE INVENTION

The present invention relates to a cleaning wipe for dishware, flatware, pots and pans which comprises approximately by weight:

(a) 5% to 80% of a cleaning composition which comprises approximately by weight:

(i) 1% to 6% of a sodium salt of a C₈-C₁₆ linear alkyl benzene sulfonate surfactant;

(ii) 7% to 13% of a magnesium salt of a C₈-C₁₆ linear alkyl benzene sulfonate surfactant;

(iii) 8% to 14% of an ammonium or sodium salt of an ethoxylated C₈-C₁₈ alkyl ether sulfate surfactant having 1 to 3 moles of ethylene oxide;

(iv) 8% to 14% of an ammonium or sodium salt of an ethoxylated alkyl ether sulfate surfactant having 5 to 10 moles of ethylene oxide;

(v) 3% to 10% of an amine oxide surfactant;

(vi) 0 to 5%, more preferably 0.5% to 4% of a hydroxy containing organic acid;

(vii) 0 to 10% of at least one solubilizing agent; and

(vii) the balance being water, wherein the composition does not contain potassium sorbate, a polysaccharide polymer, a polycarboxylate polymer, polyvinyl alcohol polymer, polyvinylpyrrolidone polymer or methyl vinyl ether polymer; and

(b) 20% to 95% of a water insoluble substrate, wherein said water insoluble substrate is impregnated with said cleaning composition.

The anionic sulfonate surfactants which may be used in the detergent of this invention are selected from compounds that are water soluble and include the sodium, potassium, ammonium, magnesium and ethanolammonium salts of linear C₈-C₁₆ alkyl benzene sulfonates; C₁₀-C₂₀ paraffin sulfonates, alpha olefin sulfonates containing about 10-24 carbon atoms and C₈-C₁₈ alkyl sulfates and mixtures thereof.

Examples of suitable sulfonated anionic detergents are the well known higher alkyl mononuclear aromatic sulfonates, such as the higher alkylbenzene sulfonates containing 9 to 18 or preferably 9 to 16 carbon atoms in the higher alkyl group in a straight or branched chain, or C₈₋₁₅ alkyl toluene sulfonates. A preferred alkylbenzene sulfonate is a linear alkylbenzene sulfonate having a higher content of 3-phenyl (or higher) isomers and a correspondingly lower content (well below 50%) of 2-phenyl (or lower) isomers, such as those sulfonates wherein the benzene ring is attached mostly at the 3 or higher (for example 4, 5, 6 or 7) position of the alkyl group and the content of the isomers in which the benzene ring is attached in the 2 or 1 position is correspondingly low. Preferred materials are set forth in U.S. Pat. No. 3,320,174, especially those in which the alkyls are of 10 to 13 carbon atoms.

Each of the two C₈₋₁₈ ethoxylated alkyl ether sulfate surfactants used in the instant compositions have the structure

R—(OCHCH₂)ₙOSO⁻₃M⁺

wherein R is an alkyl group having about 8 to about 18 carbon atoms, more preferably 12 to 15 and natural cuts, for example, C₁₂₋₁₄ or C₁₂₋₁₆ and M is an ammonium cation or a metal cation, most preferably sodium. In one of ethoxylated alkyl ether sulfate surfactants, the value of n is 1 to 2 and in the other ethoxylated alkyl ether sulfate surfactant n is 5 to 10.

The ethoxylated alkyl ether sulfate may be made by sulfating the condensation product of ethylene oxide and C₈₋₁₀ alkanol, and neutralizing the resultant product. The ethoxylated alkyl ether sulfates differ from one another in the number of carbon atoms in the alcohols and in the number of moles of ethylene oxide reacted with one mole of such alcohol. Preferred ethoxylated alkyl ether sulfates contain 12 to 15 carbon atoms in the alcohols and in the alkyl groups thereof.

Amine oxide semi-polar nonionic surfactants comprise compounds and mixtures of compounds having the formula:

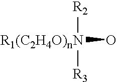

wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10. Particularly preferred amine oxides have the formula:

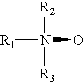

wherein R₁ is a C₁₂₋₁₆ alkyl and R₂ and R₃ are methyl or ethyl. The above ethylene oxide condensates, amides, and amine oxides are more fully described in U.S. Pat. No. 4,316,824 which is hereby incorporated herein by reference.

The instant composition can optionally contain 0 to 10 wt. %, more preferably 0.5 wt. % to 8 wt. % of a C₁₂₋₁₄ alkyl monoalkanol amide such as lauryl monoalkanol amide.

The water-soluble zwitterionic surfactant, which can be optionally used at a concentration of 7 wt. % to 13 wt. % is a water soluble betaine having the general formula:

R₂

R₁—N—R₄—COO—

R₃

wherein R₁ is an alkyl group having 10 to 20 carbon atoms, preferably 12 to 16 carbon atoms, or the amido radical:

OH

R—C—N—(CH₂)ₐ—

wherein R is an alkyl group having 9 to 19 carbon atoms and a is the integer 1 to 4; R₂ and R₃ are each alkyl groups having 1 to 3 carbons and preferably 1 carbon; R₄ is an alkylene or hydroxyalkylene group having from 1 to 4 carbon atoms and, optionally, one hydroxyl group. Typical alkyldimethyl betaines include decyl dimethyl betaine or 2-(N-decyl-N, N-dimethyl-ammonia) acetate, coco dimethyl betaine or 2-(N-coco N, N-dimethylammonio) acetate, myristyl dimethyl betaine, palmityl dimethyl betaine, lauryl diemethyl betaine, cetyl dimethyl betaine, stearyl dimethyl betaine, etc. The amidobetaines similarly include cocoamidoethylbetaine, cocoamidopropyl betaine and the like. A preferred betaine is coco (C₈-C₁₈) amidopropyl dimethyl betaine.

Polyethylene glycol which can be optionally used in the instant composition at a concentration of 0.5 wt. % to 10 wt. % has a molecular weight of 200 to 1,000, wherein the polyethylene glycol has the structure

HO(CH₂CH₂O)ₙH

wherein n is 4 to 52. The concentration of the polyethylene glycol in the instant composition is 0 to 7 wt. %, more preferably 0.1 wt. % to 5 wt. %.

The instant light duty liquid compositions can contain about 0 wt. % to about 10 wt. %, more preferably about 1 wt. % to about 8 wt. %, of at least one solubilizing agent selected from the group consisting of a C₂₋₅ mono, dihydroxy or polyhydroxy alkanols such as ethanol, isopropanol, glycerol ethylene glycol, diethylene glycol, propylene glycol, and hexylene glycol and mixtures thereof and alkali metal cumene, toluene or xylene sulfonates such as sodium cumene sulfonate and sodium xylene sulfonate. The solubilizing agents are included in order to control low temperature cloud clear properties. Urea can be optionally used at a concentration of 0.1% to 7 wt. %. Additionally, the instant compositions can contain 0 to 3 wt. %, more preferably 0.5 wt. % to 2 wt. % of an alkali metal halide such as sodium chloride.

The final essential ingredient in the inventive compositions having improved interfacial tension properties is water. The proportion of water in the compositions generally is in the range of 50% to 95%.

The liquid cleaning composition of this invention may, if desired, also contain other components either to provide additional effect or to make the product more attractive to the consumer. The following are mentioned by way of example: Colors or dyes in amounts up to 0.5% by weight; bactericides in amounts up to 1% by weight; HEDTA for color improvement under stressed sun conditions, up to 1% and pH adjusting agents, such as sulfuric acid or sodium hydroxide, as needed.

The instant compositions can contain 0 to 0.5 wt. %, more preferably 0.05 wt. % to 0.3 wt. % of a chelating agent such as penta sodium pentetate. The instant composition can also contain 0 to 10 wt. %, more preferably 0.1 wt. % to 9 wt. % of a peroxide source such as hydrogen peroxide.

Preservatives which can be optionally used in the instant compositions at a concentration of 0 wt. % to 3 wt. %, more preferably 0.01 wt. % to 2.5 wt. % are: benzalkonium chloride; benzethonium chloride,5-bromo-5-nitro-1,3dioxane; 2-bromo-2-nitropropane-1,3-diol; alkyl trimethyl ammonium bromide; N-(hydroxymethyl)-N-(1,3-dihydroxy methyl-2,5-dioxo-4-imidaxolidinyl-N′-(hydroxy methyl) urea; 1-3-dimethyol-5,5-dimethyl hydantoin; formaldehyde; iodopropynl butyl carbamate, butyl paraben; ethyl paraben; methyl paraben; propyl paraben, mixture of methyl isothiazolinone/methyl-chloroisothiazoline in a 1:3 wt. ratio; mixture of phenoxythanol/butyl paraben/methyl paraben/propylparaben; 2-phenoxyethanol; tris-hydroxyethyl-hexahydrotriazine; methylisothiazolinone; 5-chloro-2-methyl-4-isothiszolin-3-one; 1,2-dibromo-2,4-dicyanobutane; 1-(3-chloroalkyl)-3,5,7-triaza-azoniaadamantane chloride; and sodium benzoate.

A cellulosic polymer may be optionally used in the cleaning composition and is selected from the group consisting of methyl cellulose and hydroxy propyl methyl cellulose Dow Chemical manufactures these cellulosic polymers under the tradename Methocel. The following chart set forth suitable Methocel polymer useful in the instant invention.

| | Methoxyl | | | |
|---|---|---|---|---|
| | degree | | Hydroxypropyl | |
| | of | Methoxyl | degree of | Hydroxypropyl |
| | substitution | (%) | substitution | (%) |
| Methocel A | 1.8 | 30 | — | — |
| Methocel E | 1.9 | 29 | 0.23 | 8.5 |
| Methocel F | 1.8 | 28 | 0.13 | 5.0 |
| Methocel J | 1.3 | 18 | 0.82 | 27 |
| Methocel K | 1.4 | 22 | 0.21 | 8.1 |
| Methocel | 2.0 | 25 | 0.8 | 25 |
| 310 Series | | | | |

The cellulosic polymer acts to regulate and slow the release of the cleaning composition from the water insoluble substrate.

The bottom and top layers may have different textures and abrasiveness. Differing textures can result from the use of different combinations of materials or from the use of different manufacturing processes or a combination thereof. A dual texture substrate can be made to provide the advantage of a more abrasive side for cleaning difficult to remove soils. A softer side can be used for more delicate or less soiled surfaces. The substrate should not dissolve or break apart in water. It is the vehicle for delivering the cleaning composition to dishware, flatware, pots and pans. Use of the substrate enhances lathering, cleaning and grease removal.

A wide variety of materials can be used as the substrate. It should have sufficient wet strength, abrasivity, loft and porosity. Examples include, non woven substrates, woven substrates, hydroentangled substrates and sponges.

Examples of suitable non woven water insoluable substrates include, 100% cellulose Wadding Grade 1804 from Little Rapids Corporation, 100% polypropylene needlepunch material NB 701-2.8-W/R from American Non-wovens Corporation, a blend of cellulosic and synthetic fibres-Hydraspun 8579 from Ahlstrom Fibre Composites, and &0% Viscose/30% PES Code 9881 from PGI Nonwovens Polymer Corp.

Another useful substrate is manufactured by Jacob Holm-Lidro Rough'n Soft. It is a composition material comprising a 65/35 viscose rayon/polyester hydroentangled spunlace layer with a hydroenlongated bonded polyeser scribbly layer.

Still another useful substrate is manufactured by Texel. It is a composite material manufactured from a top layer of coarse fiber 100% polypropylene needlepunch, a center layer of an absorbent cellulose core manufactured by Little Rapids Corporation as Waddy Grade 1804 and a bottom layer of a fine fiber polyester layer needlepunched together. The polypropylene layer can range from 1.5 to 3.5 oz/sq. yd. The cellulose ranges from 0.5 to 2 oz./sq. yd. The fine fiber polyester layer can range from 0.5 to 2 oz./sq. yd. The fine fiber polyester layer can range from 0.5 to 2 oz./sq. yd.

The product of the present invention comprising mutliple layers may be ultrasonically bonded with appropriate choice of materials after applying the coating of one or more of the layers. Alternatively layers may be bonded together by needlepunching, thermal bonding, chemical bonding, or ultrasonic bonding prior to impregnation.

The following examples illustrate liquid cleaning compositions of the described invention. Unless otherwise specified, all percentages are by weight. The exemplified compositions are illustrative only and do not limit the scope of the invention. Unless otherwise specified, the proportions in the examples and elsewhere in the specification are by weight.

### EXAMPLE 1

The following compositions in wt. % were prepared by simple mixing procedure:

| Surfactant | A |
|---|---|
| Part I | |
| MgLAS | 9 |
| NaLAS | 3 |
| NH4AEOS 1.3 mole EO | 11.5 |
| Amine Oxide | 5.417 |
| NaAEOS 7EO | 10 |
| NaAEOS 9EO this one too | — |
| SXS hydrotrope | 1.5 |
| Salt | 1 |
| DMDMH | .11 |
| Pentasodium pentetate | .125 |
| Ethanol | 6.1 |
| Water | Bal. |
| Part I Formulas A through D | 1 |
| Fabric substrate | 1 |

¹Top coarse fiber 100% propylene layer, center cellulose layer (Waddington Grade 1804) and bottom fine fiber polyester layer wherein layers are needle punched together.

While particular embodiments of the invention and the best mode contemplated by the inventors for carrying out the invention have been shown, it will be understood, of course, that the invention is not limited thereto since modifications may be made by those skilled in the art, particularly in light of the foregoing teachings. It is, therefore, contemplated by the appended claims to cover any such modifications as incorporate those features which constitute the essential features of these improvements within the true spirit and scope of the invention.

What is claimed:

1. A cleaning wipe which comprises approximately by weight:
(a) 20% to 95% of a water insoluble substrate; and
(b) 5% to 80% of a cleaning composition which comprises approximately by weight:
(i) 1% to 6% of a sodium salt of a C₈-C₁₆ linear alkyl benzene sulfonate surfactant;
(ii) 7% to 13% of a magnesium salt of a C₈-C₁₆ linear alkyl benzene sulfonate surfactant;
(iii) 8% to 14% of an ammonium or sodium salt of an ethoxylated C₈-C₁₈ alkyl ether sulfate surfactant having 1 to 30 moles of ethylene oxide;
(iv) 8% to 14% of an ammonium or sodium salt of an ethoxylated alkyl ether sulfate surfactant having 5 to 10 moles of ethylene oxide;
(v) 3% to 10% of an amine oxide surfactant;
(vi) 0 to 10% of at least one solubilizing agent; and
(vii) the balance being water, wherein the composition has a pH of 3 to 7 and
(viii) the balance being water, wherein said water insoluble substrate is impregnated with said cleaning composition and the composition does not contain potassium sorbate, a polysaccharide polymer, a polycarboxylate polymer, polyvinyl alcohol polymer, polyvinylpyrrolidone polymer or methyl vinyl ether polymer.

2. A wipe according to claim 1 wherein said cleaning composition further includes 0.1 wt. % to 1.5 wt. % of a perfume.

3. A wipe according to claim 1, wherein said water insoluble substrates comprises a top layer bonded to a bottom layer.

4. A wipe according to claim 3, wherein said top layer comprises a coarse fiber polypropylene needlepunched and said bottom layer comprises a fine fiber polyester needlepunched.

5. A wipe according to claim 1, wherein said water insoluble substrate comprises a top layer, a center layer and a bottom layer, wherein said bottom layer, said center layer and said top layer are bonded together.

6. A wipe according to claim 5, wherein said top layer is a coarse fiber polypropylene, said center layer is an absorbent cellulose core and said bottom layer is a fine fiber polyester needlepunched.

7. A wipe according to claim 6, wherein said center layer contains at least 50 wt. % said cleaning solution.

8. A wipe according to claim 7 further including a compound selected from the group consisting of a proton donating agent, an antibacterial agent, an organic peroxide, a peroxide source, moisturizers, embollients, organic builders, inorganic builders and fabric softening agents, bleaching agents and mixtures thereof.

9. A wipe according to claim 1, wherein the composition contains a cellulosic polymer.
